(19) United States
(12) Patent Application Publication
(10) Pub. No.: US 2003/0213273 A1
(43) Pub. Date: Nov. 20, 2003

(54) Locking display gun rack

(76) Inventor: Todd L. Vercoe, Cheney, WA (US)

Correspondence Address: LEE & HAYES, PLLC, 421 W. RIVERSIDE AVE, STE 500, SPOKANE, WA, 99201, US

(21) Appl. No.: 10/152,203

(22) Filed: May 20, 2002

(51) Int. Cl. E05B 73/00

(52) U.S. Cl. 70/62

(57) ABSTRACT

Described herein is a gun display rack, comprising a stock piece having keyed ends to secure the stock of a gun, preferably through the trigger guard of the gun. The keyed ends are received by keyways in a plate, and the plate is secured to wall piece, preferably as a face plate for the wall piece. A barrel loop may be used in some embodiments to support the barrel of a gun. A method of using the gun display rack is also included.

### TECHNICAL FIELD

The present invention relates generally to firearm safety and display and more specifically to a locking display gun rack.

### BACKGROUND

Firearms are vulnerable to theft and misuse because they are valuable, portable, and desirable for trading, recreation, self-protection, and criminal activity. Since bearing arms is a Constitutional right, many Americans proudly display favorite hunting, military, and antique guns. Display of a gun, however, such as the proverbial mounting of a family rifle above the fireplace, can make the displayed gun even more vulnerable to theft or misuse.

The tension between the wide availability of guns due to the right to bear arms and the vulnerability of guns to theft and misuse has resulted in many types of gun locks, racks, and cases to secure the guns. Unfortunately, these security measures provide too little safety for a displayed gun, or, the unsightliness provided by the security measure defeats the purpose of displaying the gun. Many gun racks touted as secure are relatively easy to disassemble or are quite easy to pry, saw, or cut apart, as those who have lost guns to these devices can attest. Other security gun racks can be foiled by disassembling the gun. This happens when a professional burglar desires the gun or more commonly when a depressed person or a child in the home has extended time to figure out how to dismantle the gun, freeing the gun from the security device.

Locking a gun in an unmovable safe may provide good security, but for displayed guns in the home children, thieves, and the emotionally distraught may defeat conventional gun locks, racks, and gun cases to cause subsequent tragedy and loss.

### FIGURES

FIG. 1 is a perspective view of an example locking gun display, according to one example embodiment.

FIG. 2 is an exploded view of an example locking gun display, according to one example embodiment.

FIG. 3 is side cutaway view of an example stock mount assembly and lock, according to one example embodiment of the invention.

FIG. 4. is an exploded view of an example locking gun display, depicting an example method embodiment.

FIG. 5. is a partially exploded view of an example locking gun display, depicting an example method embodiment.

### DETAILED DESCRIPTION OF THE INVENTION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Described herein is a locking display gun rack (“locking gun display”). In its various embodiments, the locking gun display provides a secure gun display having an appearance that accentuates the firearm being displayed, thereby avoiding the obtrusive and unattractive appearance expected in gun racks that provide more than nominal security. In general, the locking gun display secures a gun such that disassembling the gun to foil the locking gun display would prove difficult or impossible.

In its embodiments, the locking gun display possesses an elegant streamlined smoothness imparting a beauty to the displayed gun equal to or surpassing that of the gun itself. The visibility of the locking gun display is kept to a minimum, so that an observer sees mostly the gun, not the locking gun display. The streamlined smoothness is also a utility feature making the locking gun display difficult or impossible to pry apart or breach in any way. When assembled to hold a gun, the various parts of the locking gun display become one or more smooth, tough assemblies with no appreciable places for a cutter, saw, or pry-bar to gain a foothold.

In some embodiments, a barrel loop may be used for a long gun, such as a rifle, carbine, or shotgun. If the barrel loop is used, the parts of the locking gun display continue to form smooth, thief-resistant assemblies when displaying a gun that are highly resistant to prying, cutting, sawing, and other dismantling of the locking gun display or the gun itself.

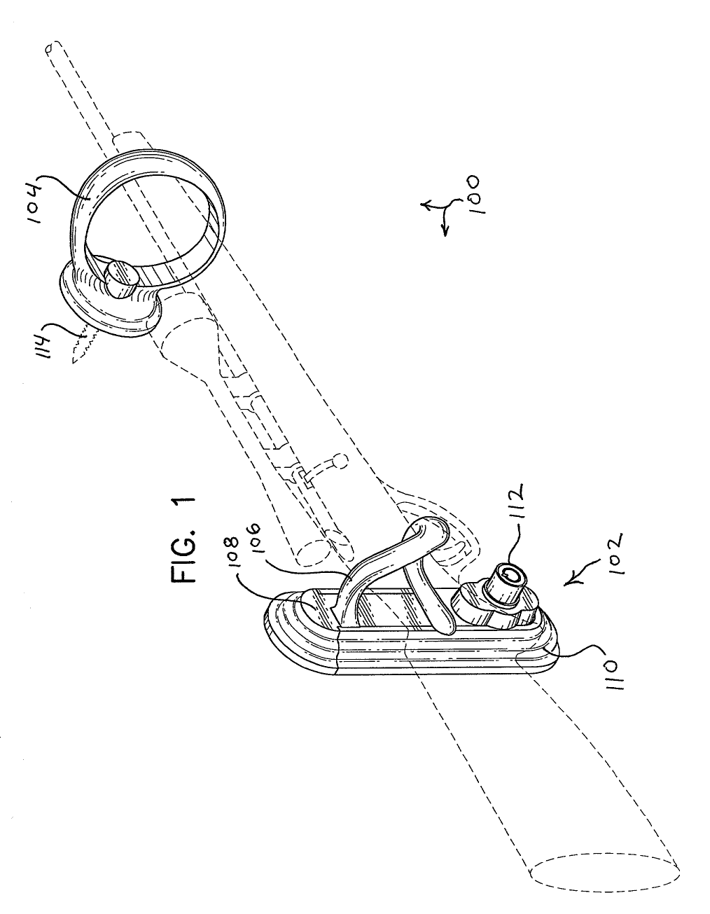

Turning now to FIG. 1, one example embodiment of a locking gun display 100 having a stock mount assembly 102 and a barrel loop 104 is illustrated. The rifle depicted in dotted lines is not part of the invention but is included to show context and relative proportion. The stock mount assembly 102 further includes a stock piece 106, a face plate 108, and a wall piece 110. A lock 112 may be included on the face plate 108 or elsewhere to secure the face plate 108 and the stock piece 106 to the wall piece 110. The barrel loop 104 is illustrated as a single piece including a mounting attachment 114. In variations, however, the barrel loop 104 may be made of a composite of parts, including for example, detachable mounting hardware.

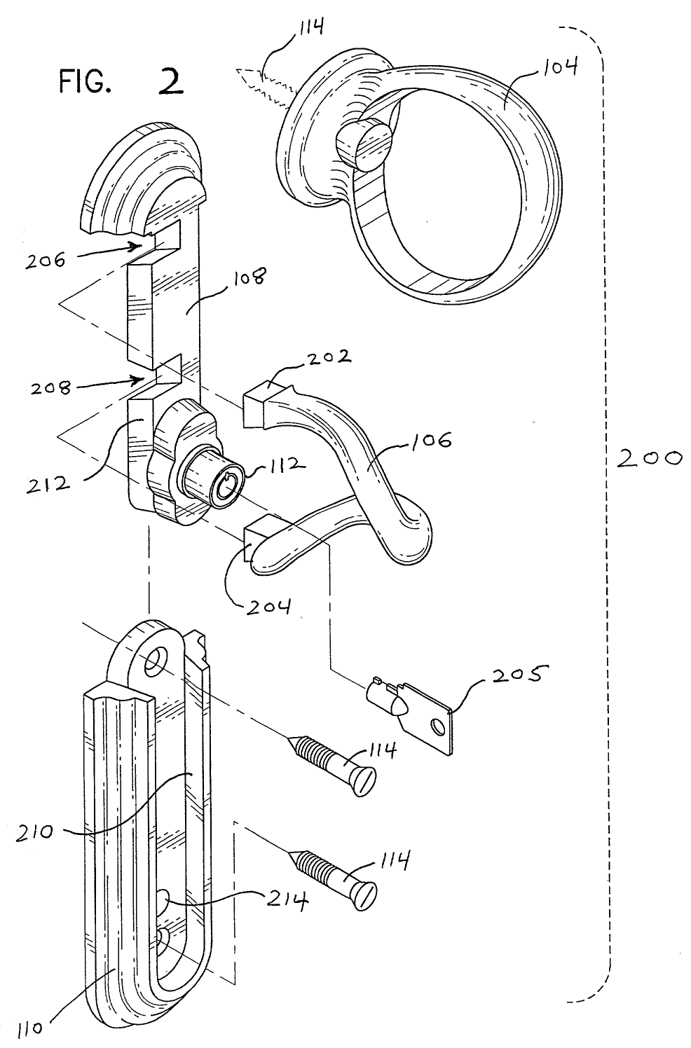

FIG. 2 shows an exploded view 200 of one example embodiment of a locking gun display. The stock piece 106 has a first tapered key end 202 and a second tapered key end 204. The stock piece 106 is passed around the stock of a gun through a trigger guard on the gun and the first tapered key end 202 and second tapered key end 204 are inserted into tapered keyways 206, 208 in the face plate 108. The stock piece 106 may be constructed of cut-resistant, saw-resistant and pry-resistant material such as brass alloy or case-hardened steel. In one embodiment the stock piece 106 is cast or molded in a single piece, or shaped from a single bar. In variations, the tapered key ends 202, 204 could be attached after the remainder of the stock piece 106 is manufactured.

The face plate 108, after being coupled with the stock piece 106, is inserted into a channel 210 in the wall piece 110. In the illustrated embodiment, the face plate 108 has tapered edges 212 to slide into a taper-edged channel 210 in the wall piece 110.

In one embodiment, a tapered fit between the face plate 108 and the wall piece 110 renders the stock mount assembly 102 highly resistant to prying apart. A pry bar edge cannot penetrate a crack between the face plate 108 and the wall piece 110 to achieve any leverage for prying apart the locking gun display. The tapered key ends 202, 204 of the stock piece 106 participate in the tapered fit between the face plate 108 and the wall piece 110 and in the illustrated embodiment form part of the tapered edge 212 of the face plate 108 when the tapered key ends 202, 204 are inserted in the keyways 206, 208 of the face plate 108.

A lock 112 may be coupled with the face plate 108, as will be discussed more fully below. In one embodiment, the lock 112 uses a key 205 that is resistant to lock picking.

In one embodiment, the barrel loop 104 is an independent member although in some embodiments the barrel loop 104 could be integrated in a single rack with the wall piece 110. In the illustrated embodiment, the barrel loop 104 has a mounting attachment, such as a screw, bolt, or wall anchor. If a screw is used for the mounting attachment 114, the presence of a gun barrel inside the barrel loop 104 eliminates the possibility of unscrewing the barrel loop 104 from a surface to remove the gun.

Mounting attachments are also used for the wall piece 110, as when the particular embodiment uses an independent wall piece 110 and barrel loop 104. The mounting attachment 114 can be, for instance, a screw, bolt, or wall anchor. Other mounting attachments 114 are feasible depending on the surface to which the locking gun display will be attached.

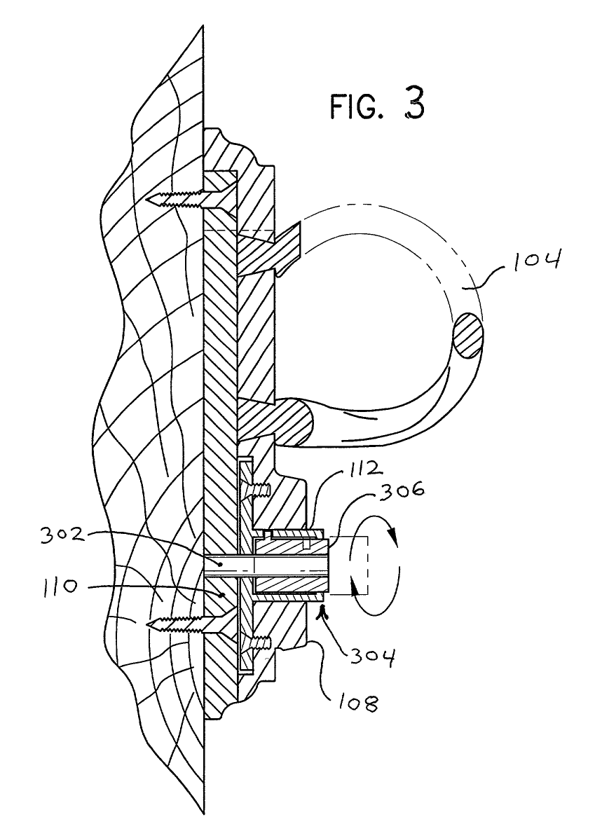

FIG. 3 shows one example embodiment of the lock 112 coupled with the face plate 108. The lock 112 may extend a bolt 302 into a hole 214 in the wall piece 110 to secure the face plate 108, the stock piece 106, (and the gun) to the wall piece 110. Other types of locks 112 or locking mechanisms may be used. One type of lock 112 that may be employed retracts flushly with a surface 304 on the face plate 108 so that when locked only the key-receiving surface 306 of the lock 112 is exposed. The retracted lock 112, flush with the surface 304 on the face plate 108, is highly resistant to prying open. A pry tool large enough to achieve significant leverage on the lock 112 cannot be inserted in any crack space around the retracted lock 112.

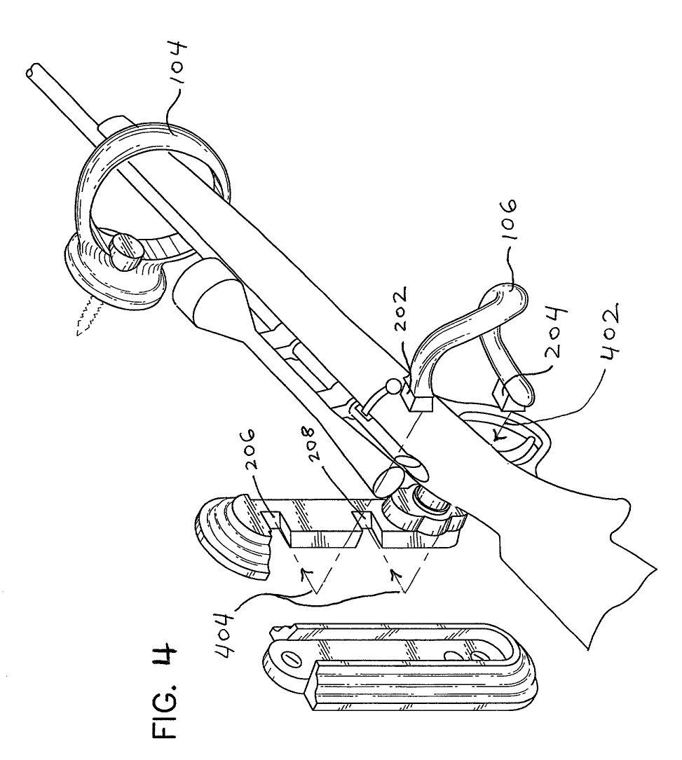

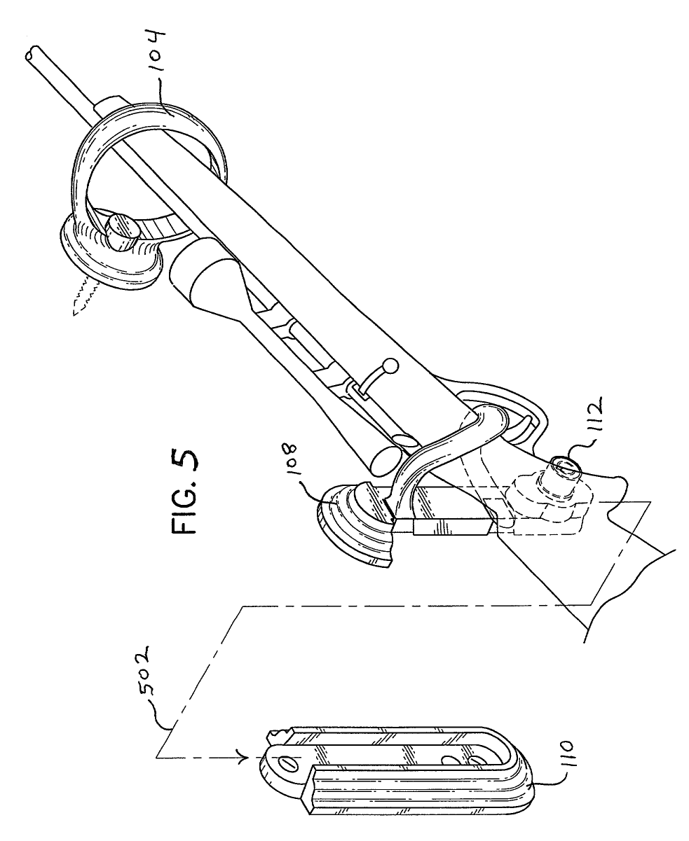

FIGS. 4 and 5 depict an example method of practicing a locking gun display. In FIG. 4, one end of a stock piece 106 having tapered key ends 202, 204 is inserted through a trigger guard of a gun (402). The tapered key ends 202, 204 are secured in keyways 206, 208 in a face plate 108 (404). In FIG. 5, the face plate 108 is secured to the wall piece 110 (502). In one embodiment, the face plate 108 has tapered edges that slide into a tapered channel in the wall piece 110. The method may further comprise securing the face plate 108 to the wall piece 110 with a lock 112. In some embodiments, the method may further comprise inserting the barrel of a long gun through a barrel loop 104.

The methods and apparatuses are described above in their most basic forms but modifications could be made without departing from the basic scope of the invention. It will be apparent to persons having ordinary skill in the art that many further modifications and adaptations can be made. The particular embodiments are not provided to limit the invention but to illustrate it. The scope of the invention is not to be determined by the specific examples provided above but only by the claims below.

1. A gun display rack, comprising:
a stock piece having a first key end and a second key end, wherein the stock piece holds a gun around a stock of the gun;
a plate having keyways to secure the first and second key ends of the stock piece; and
a wall piece having a channel to receive the plate.

2. The gun display rack of claim 1, wherein the first key end and the second key end are tapered key ends and the plate has tapered keyways to secure the first and second key ends.

3. The gun display rack of claim 1, wherein the stock piece hold a gun through a trigger guard of the gun.

4. The gun display rack of claim 1, wherein the plate is a face plate for the wall piece.

5. The gun display rack of claim 1, wherein the plate has tapered edges and the wall piece has a tapered channel to receive the plate.

6. The gun display rack of claim 1, further comprising a lock coupled with the plate to secure the plate to the wall piece.

7. The gun display rack of claim 6, wherein the lock is recessed into the plate when in a locked state.

8. The gun display rack of claim 1, wherein the stock piece is made of cut-resistant, saw-resistant and pry-resistant material.

9. The gun display rack of claim 1, wherein the stock piece is made of a single bar.

10. The gun display rack of claim 1, further comprising a barrel loop.

11. The gun display rack of claim 10, further comprising at least one mounting attachment to mount the wall piece and the barrel loop to a surface.

12. A method, comprising:
inserting one end of a stock piece having key ends around a stock of a gun;
securing the key ends in keyways in a plate; and
securing the plate to a wall piece.

13. The method of claim 12, further comprising securing the plate to the wall piece with a lock.

14. The method of claim 13, further comprising supporting a barrel of the gun in a barrel loop.

15. A gun display rack, comprising:
a curved stock piece having keyed ends to secure a gun around a stock of the gun; and
a stock mount assembly having keyways to receive the keyed ends.
